(19) United States
(12) Patent Application Publication
(10) Pub. No.: US 2013/0223712 A1
(43) Pub. Date: Aug. 29, 2013

(54) INFORMATION PROCESSING APPARATUS, INFORMATION PROCESSING METHOD AND RADIATION IMAGING SYSTEM

(71) Applicant: CANON KABUSHIKI KAISHA, (US)

(72) Inventor: Tsuyoshi Kobayashi, Yokohama-shi (JP)

(73) Assignee: CANON KABUSHIKI KAISHA, Tokyo (JP)

(21) Appl. No.: 13/761,869

(22) Filed: Feb. 7, 2013

(30) Foreign Application Priority Data
Feb. 28, 2012 (JP) 2012-042389

(51) Int. Cl. G06T 11/00

(52) U.S. Cl. CPC G06T 11/003
USPC 382/131

(57) ABSTRACT

In a first search area, the center of which is a pixel of interest within a first projected image, a first evaluation area having the pixel of interest at its center is set. A pixel at which a target the same as that of the pixel of interest has been projected is specified from the second projected image, and a second search area having this pixel at its center is set. Similarity between the area having the pixel at its center and the first evaluation area is calculated for each pixel in the first and second search areas, and the pixel values of the pixels is weighted using weight values based on the similarity. The pixel value of the pixel of interest is updated using a total value of weighted pixel values of pixels within the first and second search areas.

### BACKGROUND OF THE INVENTION

1. Field of the Invention

The present invention relates to a technique for reducing noise in radiation imaging.

2. Description of the Related Art

Diagnostic equipment that relies upon tomographic images obtained through use of radiation was developed in the 1970's and has undergone further progress and increasing utilization primarily for application in diagnostic techniques. In addition, in recent years there has been increasing exploitation of tomosynthesis, which is a method of reconstructing a tomographic image by using projected images acquired through use of limited-angle imaging.

In order to improve the image quality of such diagnostic equipment, the general practice is to execute a variety of image processing. In particular, techniques for reducing random noise contained in images is essential in order to more sharply reproduce an object that has undergone low-exposure imaging and reconstruction.

In recent years, NL-means filtering has won attention as a highly effective denoising technique (see Buades, et al., “A non-local algorithm for image denoising”, IEEE Computer Vision and Pattern Recognition, 2005, Vol. 2, pp: 60-65, 2005). This technique sets a search area around a pixel to undergo denoising, calculates the similarity between the pixel of interest and pixels inside the search area, generates a non-linear filter based upon the similarities and executes a smoothing process to thereby perform noise reduction processing. A characterizing feature of this technique is that the greater the regions of high similarity within the search area, the higher the denoising effect.

As a method that further expands upon this approach, Japanese Patent Laid-Open No. 2008-161693 discloses a technique for judging the similarity between pixels by using multiple images that differ in the time direction and then executing noise reduction processing.

Tomography captures images of the same object from various angles. As a consequence, the specific structure of the object contained in a certain image is contained also within images captured at different angles. However, when an object is imaged at a certain angle, the structure of the object projected onto a certain pixel is projected upon a different position within the image when image capture is performed at a different angle. Since the technique disclosed in Japanese Patent Laid-Open No. 2008-161693 searches for identical positions within images in the time direction, when this technique is applied to tomography, areas of low similarity are found and there is the possibility that the denoising effect will no longer be optimum. A problem which arises is that when it is attempted to widen the searched area to thereby include regions of high similarity, processing time is lengthened greatly.

### SUMMARY OF THE INVENTION

The present invention has been devised in view of the above-mentioned problem and provides a technique for implementing noise reduction processing with higher accuracy without lengthening processing time when the same object is imaged over multiple frames while the projection angle is changed.

According to one aspect of the present invention, there is provided an information processing apparatus comprising: a unit configured to acquire multiple projected images of an object captured by irradiating the object with radiation from angles that differ from one another; a first unit configured to obtain a first pixel in a first projected image among the projected images and a second pixel, which corresponds to the first pixel, from a second projected image that is different from the first projected image, based upon information relating to the angles; and a second unit configured to sum the first pixel and the second pixel at a weighting obtained based upon the information relating to the angles.

According to another aspect of the present invention, there is provided an information processing method comprising: a step of acquiring multiple projected images of an object captured by irradiating the object with radiation from angles that differ from one another; a step of obtaining a first pixel in a first projected image among the projected images and a second pixel, which corresponds to the first pixel, from a second projected image that is different from the first projected image, based upon information relating to the angles; and a step of summing the first pixel and the second pixel at a weighting obtained based upon the information relating to the angles.

According to still another aspect of the present invention, there is provided an information processing method comprising: a step of acquiring multiple projected images of an object captured by irradiating the object with radiation from angles that differ from one another; a step of setting an area, the center of which is a pixel of interest in the first projected image, as a first search area, and an area, the center of which is the pixel of interest, as a first evaluation area within the first search area; a setting step of specifying, from a second projected image that is different from the first projected image, a pixel at which a target the same as that of the pixel of interest has been projected, and setting an area, the center of which is the pixel, as a second search area; a calculation step of calculating similarity of pixel values between the area the center of which is the pixel and the first evaluation area with regard to each pixel within the first and second search areas, and weighting the pixel values of the pixels using weight values which take on smaller values the larger the similarity; and an updating step of updating the pixel value of the pixel of interest using a total value of pixel values obtained by weighting applied at the calculation step to each pixel within the first and second search areas.

According to still another aspect of the present invention, there is provided a radiation imaging system comprising: a radiation imaging apparatus configured to irradiate an object with radiation from angles that differ from one another; an apparatus configured to acquire radiation, which has been emitted from the radiation imaging apparatus and has passed through the object, as multiple projected images; and an information processing apparatus, comprising: a unit configured to obtain a first pixel in a first projected image among the projected images and a second pixel, which corresponds to the first pixel, from a second projected image that is different from the first projected image, based upon information relating to the angles; and a unit configured to sum the first pixel and the second pixel at a weighting obtained based upon the information relating to the angles.

Further features of the present invention will become apparent from the following description of exemplary embodiments with reference to the attached drawings.

### BRIEF DESCRIPTION OF THE DRAWINGS

FIG. 1 is a block diagram illustrating an example of the configuration of a radiation imaging system;

FIG. 2 is a flowchart of processing executed by a information processing apparatus 107;

FIGS. 3A and 3B are drawings for describing the positional relationship between a radiation imaging apparatus 101 and a detection unit 104;

FIG. 4 is a flowchart illustrating the details of processing at a step S203;

FIGS. 5A and 5B are specific examples of processing executed in the flowchart of FIG. 4; and

FIG. 6 is a diagram for describing processing executed at step S402.

### DESCRIPTION OF THE EMBODIMENTS

An embodiment of the present invention will be described below with reference to the accompanying drawings. It should be noted that the embodiment described below illustrates one example of a case where the present invention is implemented in concrete form and is one specific embodiment of the arrangement set forth in the claims.

### First Embodiment

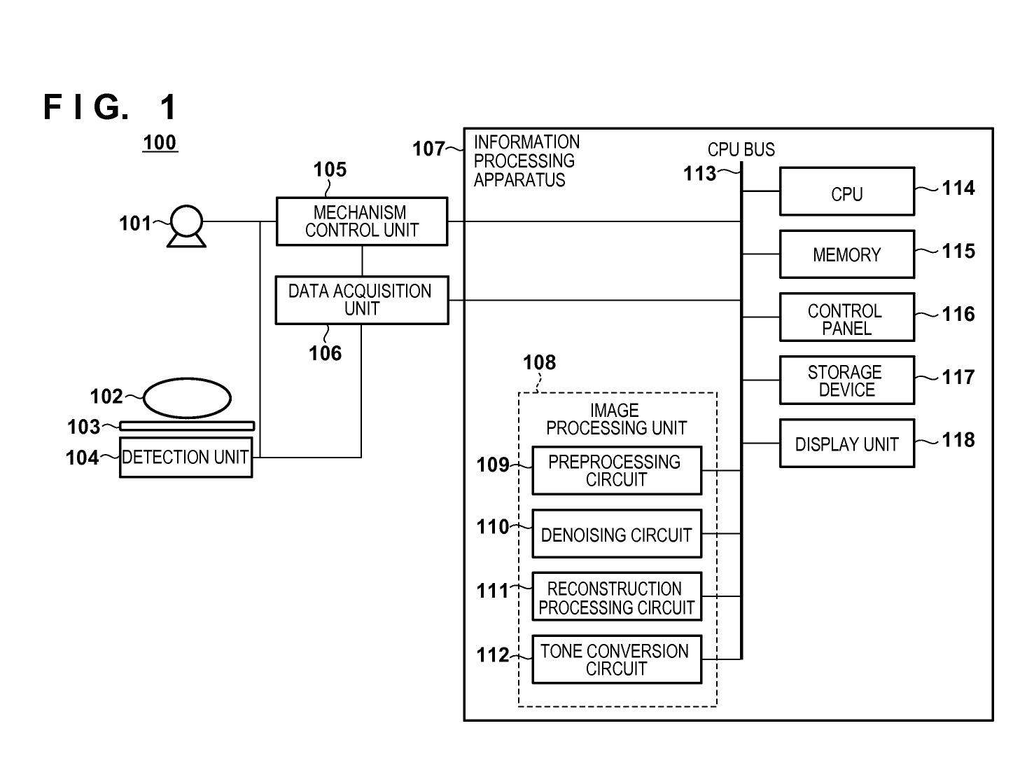

First, reference will be had to the block diagram of FIG. 1 to describe an example of the configuration of a radiation imaging system 100 to which an information processing apparatus according to this embodiment is applied. The radiation imaging system 100 of FIG. 1 has a tomosynthesis imaging function for irradiating an object with radiation from angles that differ from one another, thereby capturing multiple projected images of the object, and executing reconstruction processing using the multiple projected images thus captured, thereby generating a tomographic image of the object. In such a system, according to this embodiment, each projected image captured is subjected to noise reduction processing described later.

The radiation employed in the description that follows is not limited solely to commonly used X-rays but includes α-rays, β-rays and γ-rays, which are beams formed by particles (inclusive of photos) emitted by radioactive decay, as well as beams having the same or greater energy, examples of which are particle beams and cosmic rays and the like.

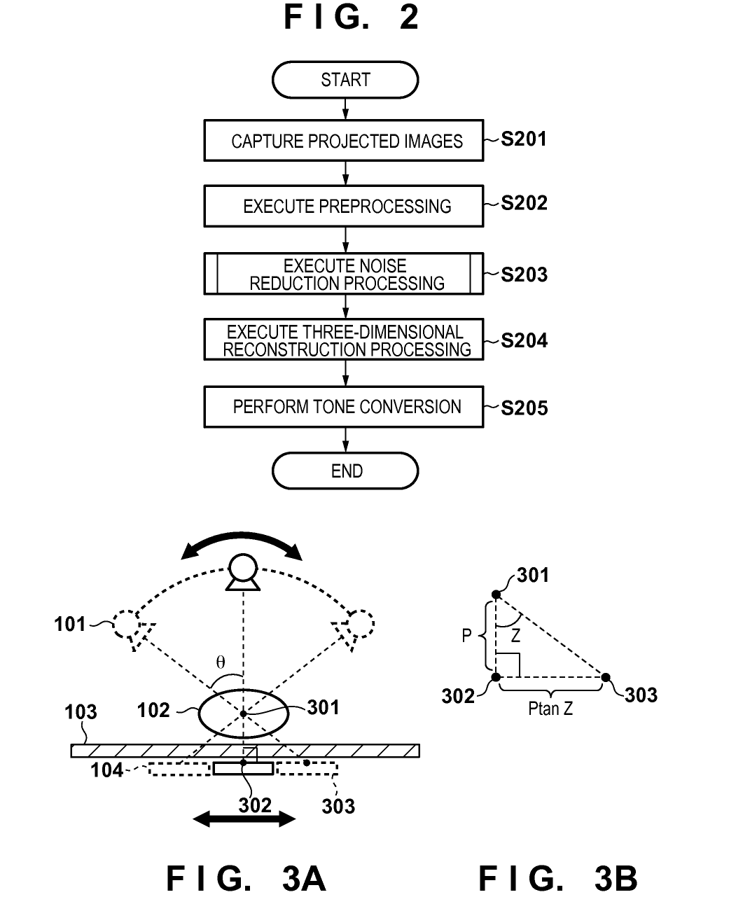

The operation of each of the components shown in FIG. 1 will be described with reference to FIG. 2, which is a flowchart of processing executed by an information processing apparatus 107. Each step in the flowchart of FIG. 2 is implemented by having a CPU 114 execute processing using a computer program and data that have been stored in a memory 115, or by having the CPU 114 control the corresponding functional units.

At step S201, the CPU 114 sends an imaging-start instruction to a mechanism control unit 105 via a CPU bus 113 when detecting the imaging-start instruction has been input by an operator operating a control panel 116.

Upon receiving the imaging-start instruction from the CPU 114, the mechanism control unit 105 controls a radiation imaging apparatus 101 and a detection unit 104 and irradiates an object 102, which has been placed on a bed 103, with radiation from angles that differ from one another, thereby capturing multiple projected images of the object 102.

More specifically, the mechanism control unit 105 controls radiation generating conditions such as voltage, current and irradiation period and causes the radiation imaging apparatus 101 to generate radiation under predetermined conditions (conditions that the operator has entered by operating the control panel 116). The radiation emitted from the radiation imaging apparatus 101 is detected by the detection unit 104 upon passing through the object 102. The detection unit 104 detects the radiation that has passed through the object 102 and sends a data acquisition unit 106 an electric signal that conforms to the amount of radiation detected. The data acquisition unit 106 produces an image, which is based upon the electric signal received from the detection unit 104, as a projected image, and sends to the information processing apparatus 107 the projected image thus produced. A projected image resulting from radiation imaging from one direction can be captured by this series of processes.

By carrying out such radiation imaging multiple times while changing the positional relationship between the radiation imaging apparatus 101 and the detection unit 104, the object 102 is irradiated with radiation from angles that differ from one another, whereby multiple projected images of the object 102 can be captured. Reference will be had to FIG. 3A to describe the positional relationship between the radiation imaging apparatus 101 and detection unit 104 in such imaging of multiple projected images.

As shown in FIG. 3A, the radiation imaging apparatus 101 emits radiation while revolving about the body axis of the object 102 (about a position 301 at the center of revolution) in order to irradiate the object 102 with radiation from different angles. The detection unit 104, which is adapted so as to be movable transversely in the plane of the drawing, moves to a position opposite the radiation imaging apparatus 101, with the object 102 interposed therebetween, in order to detect the radiation that has been emitted from the radiation imaging apparatus 101 and has passed through the object 102. In other words, the detection unit 104 undergoes translational motion so as to be situated on a straight line that passes through the position of the radiation imaging apparatus 101 and the position 301 at the center of revolution.

In FIG. 3A, the radiation imaging apparatus 101 revolves around the position 301 over a range of angles from −θ to +θ degrees (e.g., −40 to +40 degrees). An angle Z of revolution (radiation projection angle) is an angle defined by a straight line passing through the radiation imaging apparatus 101 and position 301 at the center of revolution and a straight line passing through a position 302 at the center of range of movement of the detection unit 104 and the position 301 at the center of revolution.

For example, by performing a single emission of radiation whenever the radiation projection angle Z is changed by one degree, thereby to capture a single projected image, a projected image can be captured for each angle Z. For example, if 80 projected images are captured at 15 FPS (Frame Per Second), then image acquisition can be performed in about 5 seconds. Although it is possible to set any conditions as the radiation imaging conditions, values on the order of 100 kV and 1 mAs will suffice when imaging the human chest or the like. Further, the distance between the detection unit 104 and the radiation imaging apparatus 101 is set within a range of 100 to 150 cm that has been established for fluoroscopic equipment or for ordinary imaging equipment.

The detection unit 104, on the other hand, moves to a position opposite the radiation imaging apparatus 101, with the object 102 interposed therebetween, whenever the radiation projection angle Z changes. Whenever the radiation projection angle Z changes, the mechanism control unit 105 calculates the amount of movement of the detection unit 104 and moves the detection unit 104 by the amount of movement calculated. The calculation of the amount of the movement will be described with reference to FIG. 3B.

In a case where the radiation projection angle has changed to Z, as shown in FIG. 3B, the distance the detection unit 104 travels from the position 302 is given by PtanZ, where P represents the distance between the position 301 at the center of revolution and the position 302. That is, by moving the detection unit 104 from the position 302 to a position 303 obtained by movement equivalent to PtanZ, the detection unit 104 can detect the radiation emitted from the radiation imaging apparatus 101 even though this radiation is emitted at the radiation projection angle Z. The straight line passing through the position of the radiation imaging apparatus 101 and the position 303 of the detection unit 104 after movement thereof always passes through the position 301 at the center of revolution.

Since multiple projected images are captured at step S201, the projected images captured are stored in the memory 115 one after the other.

With reference again to FIG. 2, in step S202, a preprocessing circuit 109 within an image processing unit 108 successively reads out the projected images that have been stored in the memory 115 and subjects the read-out projected images to preprocessing such as an offset correction process, gain correction process and defect correction process. The preprocessing circuit 109 stores the preprocessed projected images in the memory 115.

At step S203, a denoising circuit 110 within the image processing unit 108 successively reads out the preprocessed projected images that have been stored in the memory 115 and subjects the read-out projected images to processing for reducing noise. The details of the processing executed at step S203 will be described later. The denoising circuit 110 stores the denoised projected images in the memory 115.

At step S204, a reconstruction processing circuit 111 within the image processing unit 108 reads from the memory 115 each projected image denoised by the denoising circuit 110 and executes three-dimensional reconstruction processing using each projected image, thereby generating a single tomographic image. The three-dimensional reconstruction processing executed here can employ any well-known method. For example, it is possible to utilize an FBP (Filtered Back Projection) method using a reconstruction filter, or a sequential approximation reconstruction method. The reconstruction processing circuit 111 stores the generated tomographic image in the memory 115.

At step S205, a tone conversion circuit 112 within the image processing unit 108 reads from the memory 115 the tomographic image generated by the reconstruction processing circuit 111 and subjects the read-out tomographic image to suitable tone conversion processing. In accordance with the instruction input by the operator operating the control panel 116, the CPU 114 displays the tone-converted tomographic image on a display unit 118 or stores this tomographic image in a storage device 117. The output destination or handling of the tone-converted tomographic image is not limited to any specific kind.

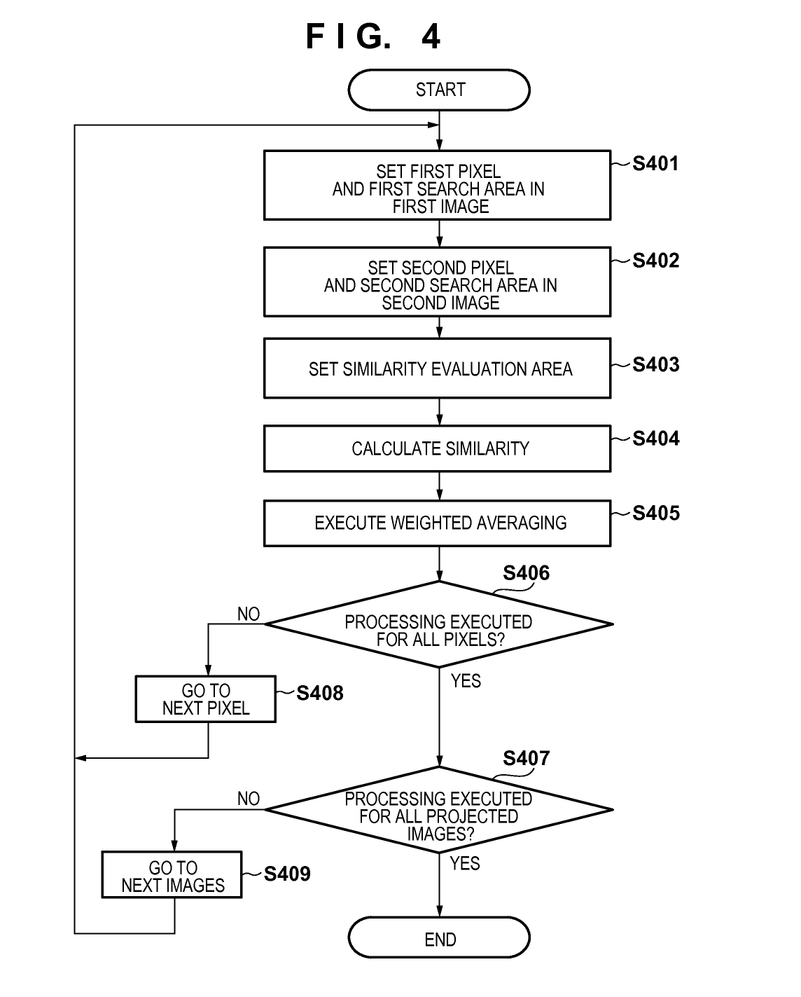

Next, the details of the processing executed at step S203 will be described with reference to FIG. 4 showing a flowchart of the this processing.

At step S401, the denoising circuit 110 reads a projected image, which has not yet undergone noise reduction processing, from the memory 115 as a first projected image, and sets an area, the center of which is a pixel position (X,Y) within the first projected image read out, as a first search area. It should be noted that in a case where the processing of step S401 is initially applied to the projected image read out from the memory 115, X =Y=0 holds.

At step S402, the denoising circuit 110 reads a projected image, which has been captured at a projection angle different from that of the first projected image, from the memory 115 as a second projected image. In the second projected image the denoising circuit 110 specifies a pixel at which a target the same as that of the pixel (pixel of interest) at the pixel position (X,Y) in the first projected image has been projected, and sets an area having this specified pixel at its center as a second search area. The details of the processing executed at step S402 will be described later.

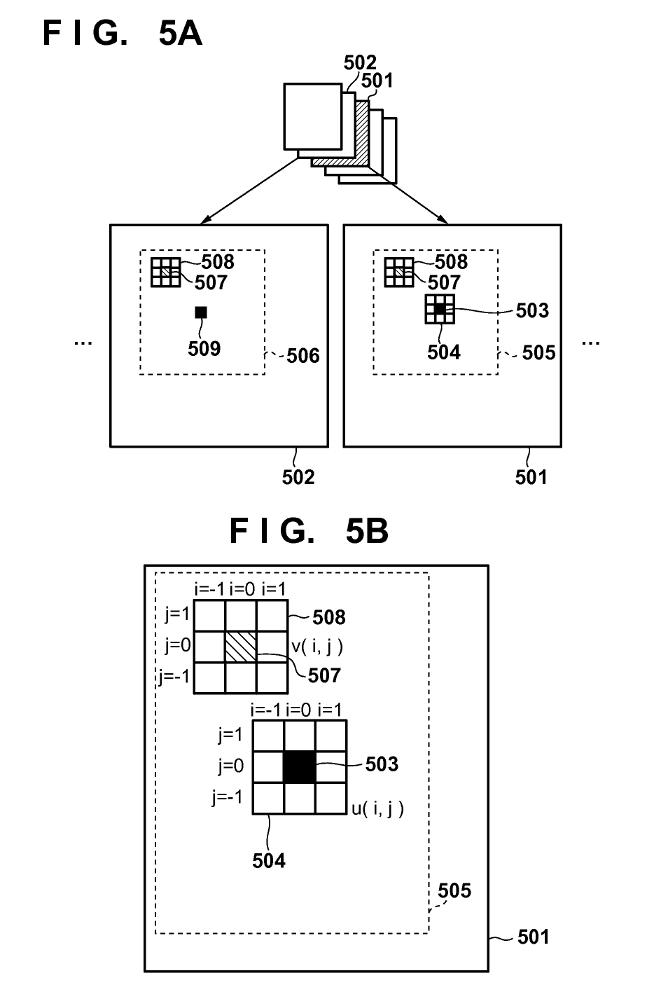

The processing executed at steps S401 and S402 will now be described taking FIG. 5A as an example.

At step S401, a projected image 501 is read from the memory 115 as a projected image that has not yet undergone noise reduction processing, and a first search area 505 having a pixel 503 of interest at its center is set in the projected image 501.

At step S402, a projected image 502 that has been captured at a projection angle different from that of the projected image 501 is read from the memory 115. A pixel at which a target the same as that of the pixel 503 of interest has been imaged is specified as a pixel 509 in the projected image 502, and a second search area 506 having the pixel 509 at its center is set in the projected image 502. Here the size of the second search area 506 may be decided, for example, in accordance with the difference between an irradiation angle at which the projected image 501 is captured and an irradiation angle at which the projected image 502 is captured. For example, the larger the difference between the two irradiation angles, the more the size of the second search area 506 is made smaller than that of the first search area 505.

At step S403, the denoising circuit 110 sets an area, the center of which is the pixel of interest, as a first evaluation area within the first search area. In the example of FIG. 5A, a 3×3 pixel area comprising the pixel 503 of interest and eight pixels neighboring the pixel 503 has been set as a first evaluation area 504. The size of the first evaluation area is made smaller than that of the second search area.

At step S404, the denoising circuit 110 calculates, for each pixel in the first and second search areas, the similarity of pixel values between the area having the pixel at its center and the first evaluation area.

In the example of FIG. 5A, a 3×3 pixel area comprising a pixel 507 at a pixel position (x,y) and eight pixels neighboring the pixel 507 has been set as a second evaluation area 508, out of each pixel position inside the first and second search areas. It is assumed that the size of the second evaluation area 508 is the same as that of the first evaluation area 504. Similarity Iv(x,y) of pixel values between the second evaluation area 508 and the first evaluation area 504 is calculated.

Reference will be had to FIG. 5B to describe one example of calculation processing for calculating the similarity of pixel values between the second evaluation area 508 and the first evaluation area 504. In FIG. 5B, let a pixel position within the second evaluation area 508 be represented by v(i,j) [where the position of pixel 507 is v(0,0)], and let a pixel position within the first evaluation area 504 be represented by u(i,j) [where the position of the pixel 503 of interest is u(0,0)]. In such case the similarity Iv(x,y) of pixel values between the second evaluation area 508 and the first evaluation area 504 can be calculated by using the following equation:

$${I}_{v} ( x , y ) = \frac{1}{D} {\sum }_{i} {\sum }_{j} {\{ u ( i , j ) - v ( i , j ) \}}^{2} exp ( - \frac{{i}^{2} + {j}^{2}}{{h}_{1}^{2}} )$$

$$D = {\sum }_{x} {\sum }_{y} {I}_{v} ( x , y )$$

Specifically, for every set of positionally corresponding pixels [a set of pixels (first pixel and second pixel) for both of which i,j are the same] between the second evaluation area 508 and the first evaluation area 504, the square of the difference between the pixel values is weighted by a weight value depending on the distance from the pixel 507 or from the pixel 503 of interest. The results of such weighting applied to every set are totalized (summed) and the result of such totalization is adopted as the degree of similarity.

Such similarity Iv(x,y) is calculated for each pixel position within the first and second search areas [that is, with regard to all (x,y) in the first search area and second search area]. It should be noted that the method of calculating similarity is not limited to the method of calculating the sum of the squares of the differences indicated in this example; any already known indicator may be used, such as the sum of absolute values of differences or a normalized correlation.

At step S405, the denoising circuit 110 subjects the pixel value of pixel at each of the pixel positions within the first and second search areas to weighting using weight values which take on smaller values the larger the similarity calculated with regard to the pixel position. The denoising circuit 110 then updates the pixel value of the pixel of interest using the totalized value of the pixel values weighted. More specifically, if we let w(x,y) represent the pixel value of a pixel at pixel position (x,y) in the first and second search areas, then a new pixel value u(X,Y) of the pixel of interest at pixel position (X,Y) can be calculated by performing the calculation indicated by the following equation:

$$u ( X , Y ) = \frac{1}{C} {\sum }_{x} {\sum }_{y} exp ( - \frac{{I}_{v} ( x , y ) G}{{h}_{2}^{2}} ) w ( x , y )$$

$$C = {\sum }_{x} {\sum }_{y} u ( X , Y )$$

In this equation, G represents a constant that corresponds to the distance between the pixel position (x,y) and the pixel position (X,Y). For example, the greater the distance, the smaller the value of G.

At step S406, the denoising circuit 110 determines whether a new pixel value has been calculated with regard to all pixels in the first projected image. If the result of such a determination is that a pixel for which a new pixel value has not yet been calculated remains, then processing proceeds to step S408. On the other hand, if a new pixel value has been calculated for all pixels in the first projected image, then processing proceeds to step S407.

At step S408, the denoising circuit 110 updates the pixel position (X,Y). For example, if the projected image is processed line by line in the order of pixels from the left-end pixel to the right-end pixel, the denoising circuit 110 increments X by one. When X reaches the right end of the projected image, the denoising circuit 110 increments Y by one upon setting X at X=0. Processing then returns to step S401 and the denoising circuit 110 sets the area having the updated pixel position (X,Y) at its center as the first search area in the first projected image.

At step S407, the denoising circuit 110 determines whether noise reduction processing has been carried out with regard to all projected images that have been stored in the memory 115. If the result of the determination is that noise reduction processing has been executed with regard to all projected images, then the processing of the flowchart of FIG. 4 is quit and control proceeds to step S204. On the other hand, if a projected image that has not yet undergone noise reduction processing remains in the memory 115, then control proceeds to step S409.

At step S409, the denoising circuit 110 selects a projected image, which has not yet undergone noise reduction processing, as a target image to be read out from the memory 115 next. Control then returns to step S401. Here the denoising circuit 110 reads the projected image, which has been selected at step S409, from the memory 115 as the first projected image and subjects this read-out projected image to processing from this step onward.

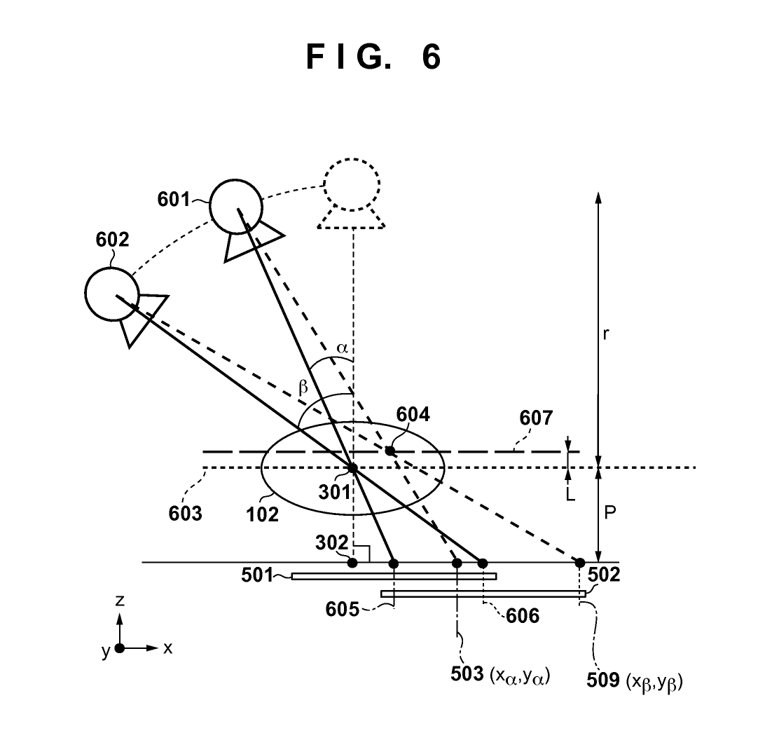

Next, reference will be had to FIG. 6 to describe the processing executed at step S402 in order to specify, in the second projected image, a pixel at which a target the same as that of the pixel (pixel of interest) at the pixel position (X,Y) in the first projected image has been projected.

In FIG. 6, a projected image obtained as a result of the radiation imaging apparatus 101 emitting radiation at the irradiation angle α is the projected image 501, and a projected image obtained as a result of the radiation imaging apparatus 101 emitting radiation at the irradiation angle β is the projected image 502.

Consider, as a point of interest in the object 102, a point 604 in a slice 607 of interest of the object 102 obtained by shifting a slice 603, which passes through the position 301 at the center of revolution, in the Z direction by a distance L. Assume that a point at which the point 604 of interest is projected upon the projected image 501 is the pixel 503 of interest. Further, let (Xa,Ya) represent the coordinates of the pixel 503 of interest when a center point 605 of the projected image 501 is taken as the origin.

Further, in a manner similar to that of the pixel 503 of interest, assume that a point at which the point 604 of interest is projected upon the projected image 502 is a pixel 509, and let (4,4)represent the coordinates of the pixel 509 when a center point 606 of the projected image 502 is taken as the origin. If we let r represent the radius of revolution, then the coordinates (4,4) can be expressed by the following equations:

$${x}_{β} = \frac{( r cos α - L ) ( r cos β + P )}{( r cos α + P ) ( r cos β - L )} {x}_{α} - \{ \frac{r sin α + P tan α}{r cos α + P} - \frac{r sin β + P tan β}{r cos β - L} \} L$$

$${y}_{β} = \frac{( r cos α - L ) ( r cos β + P )}{( r cos α + P ) ( r cos β - L )} {y}_{α}$$

Here L takes on any value inside the thickness of the object, where the slice passing through the position 301 at the center of revolution is adopted as the origin. Here a certain plane of the object structure where it is desired to further increase the denoising effect should be selected as L. As a result of the processing described above, it is possible to calculate at which position inside an image that has been captured at the irradiation angle β will be projected an object structure that has been projected upon any pixel of an image that has been captured at the irradiation angle α.

In accordance with this embodiment, as described above, when denoising of a certain pixel is carried out, an area of high similarity can be selected efficiently from multiple images. As a result, it is possible to further optimize noise reduction processing that relies upon a non-linear filter produced based upon similarity, and an image denoised at a performance higher than that of the prior-art techniques can be obtained.

Further, although the embodiment has been described taking a tomosynthesis imaging apparatus as an example, the present invention can be modified and changed in various ways within the gist. For instance, the present invention is applicable to all kinds of apparatus, such as a CT apparatus, for imaging the same object from various angles.

### Second Embodiment

In the first embodiment, noise reduction processing is executed within the image processing unit 108 incorporated in the information processing apparatus 107 contained in the system shown in FIG. 1. However, so long as the apparatus includes a computer that is capable of acquiring multiple projected images captured by this system, such noise reduction processing may be executed by an apparatus that is outside this system. For example, if multiple projected images captured by such a system are registered in a database or the like beforehand, then an ordinary personal computer or the like can acquire these projected images by accessing the database. Thus, the personal computer can perform the above-described noise reduction processing to each of these projected images.

Further, although each unit within the image processing unit 108 is composed of hardware, these units can be implemented by a computer program. In such case the computer program is stored in the storage device 117 and the CPU 114 reads the program out to the memory 115 and executes the program as necessary, thereby allowing the CPU 114 to implement the function of each unit within the image processing unit 108. Naturally, the computer program can be executed by an apparatus outside the system.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-042389 filed Feb. 28, 2012, which is hereby incorporated by reference herein in its entirety.

What is claimed is:

1. An information processing apparatus comprising:
a unit configured to acquire multiple projected images of an object captured by irradiating the object with radiation from angles that differ from one another;
a first unit configured to obtain a first pixel in a first projected image among the projected images and a second pixel, which corresponds to the first pixel, from a second projected image that is different from the first projected image, based upon information relating to the angles; and
a second unit configured to sum the first pixel and the second pixel at a weighting obtained based upon the information relating to the angles.

2. The apparatus according to claim 1, wherein said first unit includes a setting unit configured to set a first search area, the center of which is a pixel of interest in the first projected image, and a second search area, the center of which is a pixel at which a target the same as that of the pixel of interest has been projected from the second projected image that is different from the first projected image; and
said second unit sums each pixel within the first and second search areas based upon similarity of pixel values between an area in which this pixel is the center and the first search area.

3. The apparatus according to claim 2, wherein said second unit weights the pixel values of the pixels using weight values which take on smaller values the larger the similarity.

4. The apparatus according to claim 2, further comprising an updating unit configured to update the pixel value of the pixel of interest using a total value of pixel values obtained by weighting applied by said second unit to each pixel within the first and second search areas.

5. The apparatus according to claim 2, wherein said setting unit converts the pixel position of the pixel of interest using an irradiation angle when the first projected image was captured and an irradiation angle when the second projected image was captured, and specifies the pixel at the converted pixel position as a pixel at which a target the same as that of the pixel of interest has been projected.

6. The apparatus according to claim 2, wherein said setting unit sets the second search area to be smaller in size the greater the difference between an irradiation angle when the first projected image was captured and an irradiation angle when the second projected image was captured.

7. The apparatus according to claim 2, wherein said second unit performs weighting of the pixel values of the pixels, with regard to each pixel within the first and second search areas, using weight values that take on smaller values the greater the distance between the pixel and the pixel of interest.

8. The apparatus according to claim 4, further comprising a unit configured to generate a tomographic image of the object by executing reconstruction processing using the multiple projected images in which the pixel values have been updated by said updating unit.

9. An information processing method comprising:
a step of acquiring multiple projected images of an object captured by irradiating the object with radiation from angles that differ from one another;
a step of obtaining a first pixel in a first projected image among the projected images and a second pixel, which corresponds to the first pixel, from a second projected image that is different from the first projected image, based upon information relating to the angles; and
a step of summing the first pixel and the second pixel at a weighting obtained based upon the information relating to the angles.

10. An information processing method comprising:
a step of acquiring multiple projected images of an object captured by irradiating the object with radiation from angles that differ from one another;
a step of setting an area, the center of which is a pixel of interest in the first projected image, as a first search area, and an area, the center of which is the pixel of interest, as a first evaluation area within the first search area;
a setting step of specifying, from a second projected image that is different from the first projected image, a pixel at which a target the same as that of the pixel of interest has been projected, and setting an area, the center of which is said pixel, as a second search area;
a calculation step of calculating similarity of pixel values between the area the center of which is said pixel and the first evaluation area with regard to each pixel within the first and second search areas, and weighting the pixel values of the pixels using weight values which take on smaller values the larger the similarity; and
an updating step of updating the pixel value of the pixel of interest using a total value of pixel values obtained by weighting applied at said calculation step to each pixel within the first and second search areas.

11. A non-transitory computer-readable storage medium storing a computer program for causing a computer to function as each of the units of the information processing apparatus set forth in claim 1.

12. A radiation imaging system comprising:
a radiation imaging apparatus configured to irradiate an object with radiation from angles that differ from one another;
an apparatus configured to acquire radiation, which has been emitted from said radiation imaging apparatus and has passed through the object, as multiple projected images; and
an information processing apparatus, comprising:
a unit configured to obtain a first pixel in a first projected image among the projected images and a second pixel, which corresponds to the first pixel, from a second projected image that is different from the first projected image, based upon information relating to the angles; and
a unit configured to sum the first pixel and the second pixel at a weighting obtained based upon the information relating to the angles.
